(19) United States
(12) Patent Application Publication
(10) Pub. No.: US 2003/0183275 A1
(43) Pub. Date: Oct. 2, 2003

(54) HOT AND COLD WATER MIXING FAUCET HAVING CHECK VALVE

(76) Inventor: Tsai Chen Yang, Taichung (TW)

Correspondence Address: Tsai Chen YANG, P.O. Box 63-99, Taichung, 406, TW

(21) Appl. No.: 10/105,267

(22) Filed: Mar. 26, 2002

(51) Int. Cl. G05D 11/00

(52) U.S. Cl. 137/98

(57) ABSTRACT

A faucet housing includes two barrels each having an inlet port for receiving hot and cold water, and an outlet port. A receptacle and two conduits are coupled between the barrels. One of the barrels has a partition for separating the barrel into two spaces and for communicating with the conduits. A casing is disposed in the other barrel and the receptacle and has a bore for receiving a tube and a valve member. One or more check valves are engaged in either or both of the inlet ports of the barrels for preventing backward water flow and for maintaining water pressure in the housing.

### BACKGROUND OF THE INVENTION

1. Field of the Invention

The present invention relates to a faucet, and more particularly to a faucet assembly for mixing hot water and cold water and having check valves for preventing water from flowing backwardly away from the faucet.

2. Description of the Prior Art

Various kinds of typical valves have been developed for receiving the hot water and the cold water and for allowing the hot water and the cold water to be mixed before flowing out of a faucet assembly, and/or for preventing only the hot water to flow out of the faucet assembly and to hurt people inadvertently.

U.S. Pat. No. 5,839,471 to the present applicant Yang, and U.S. Pat. No. 6,176,250 to Lin et al., disclose two of the typical valves for mixing the hot water and the cold water and for preventing only the hot water to flow out of the faucet assembly. However, the faucet assemblies have no devices for preventing the water from flowing backwardly away from the faucet assembly and for maintaining the constant water pressure in the faucet assembly.

The present invention has arisen to mitigate and/or obviate the afore-described disadvantages of the conventional faucet assemblies.

### SUMMARY OF THE INVENTION

The primary objective of the present invention is to provide a faucet assembly for suitably mixing the hot water and the cold water and having a check valve device for preventing water from flowing backwardly away from the faucet assembly and for maintaining the constant water pressure in the faucet assembly.

In accordance with one aspect of the invention, there is provided a faucet assembly comprising a first barrel and a second barrel each including an inlet port for coupling to hot water and cold water reservoirs respectively for receiving hot water and cold water from the reservoirs respectively, and each including a middle portion, the first barrel including a partition provided in the middle portion of the first barrel for separating an interior of the barrel into two spaces, a receptacle and two conduits coupled between the middle portions of the first and the second barrels, the conduits being communicating with the spaces of the first barrel respectively, the receptacle including a chamber formed and provided therein, a casing provided in the middle portion of the second barrel and the chamber of the receptacle, and including a bore formed therein, including at least one passage formed therein for communicating the bore of the casing with the chamber of the receptacle, and including at least one passageway formed therein for communicating the bore of the casing with the chamber of the second barrel, a tube engaged and secured into the bore of the casing, and including a hole formed therein, and including an outer peripheral portion having at least one first and at least one second peripheral channels formed therein, and including two apertures formed therein for communicating the first and the second peripheral channels of the tube with the hole of the tube, a valve member slidably engaged in the hole of the tube, and a first check valve including a pipe engaged in the inlet port of the first barrel and having at least one orifice formed through the pipe for allowing the water to flow into the first barrel, a valve stem slidably engaged through the pipe, a plug secured to the valve stem for selectively blocking the orifice of the pipe, and means for biasing the plug to engage with the pipe and to block the orifice of the pipe.

A second check valve is further provided and includes a second pipe engaged in the inlet port of the second barrel, the second pipe includes at least one orifice formed through the second pipe for allowing the water to flow into the second barrel, a valve stem slidably engaged through the second pipe, a plug secured to the valve stem for engaging with the second pipe and for selectively blocking the orifice of the second pipe, and means for biasing the plug to engage with the second pipe and to block the orifice of the second pipe.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a faucet assembly in accordance with the present invention;

FIG. 2 is a cross sectional view taken along lines 2-2 of FIG. 1, illustrating the faucet housing of the faucet assembly; and

FIGS. 3 and 4 are cross sectional views illustrating the operation of the faucet assembly.

### DETAILED DESCRIPTION OF THE PREFERRED EMBODIMENT

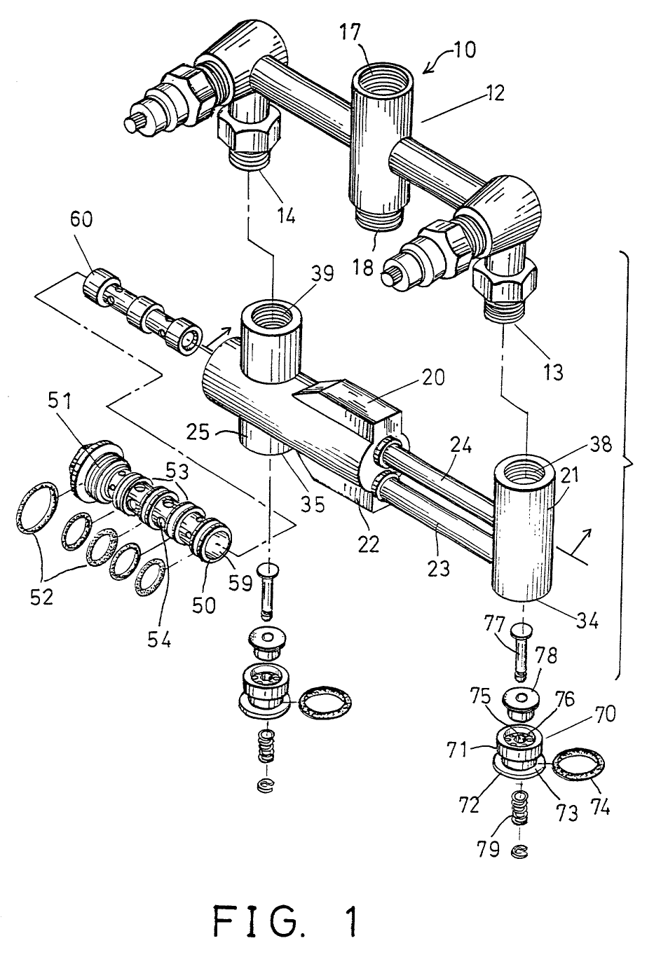

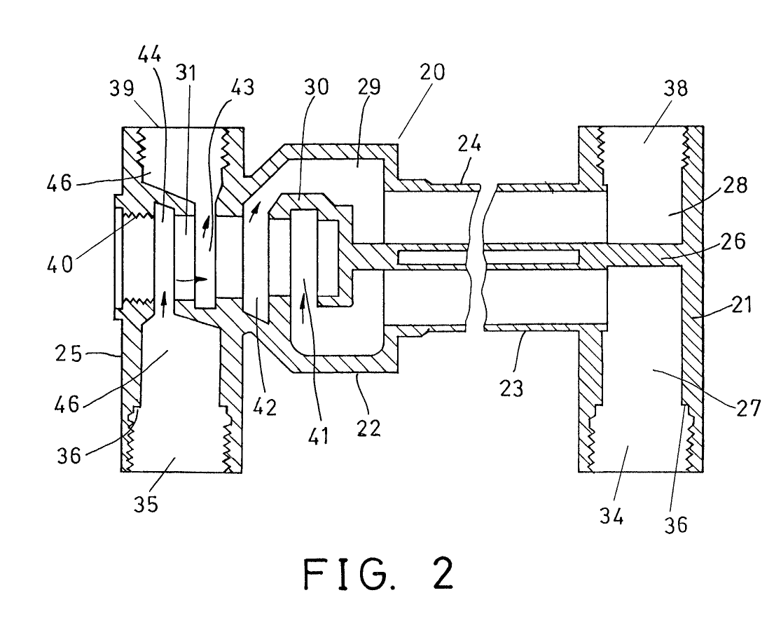

Referring to the drawings, and initially to FIGS. 1-3, a faucet assembly 10 in accordance with the present invention comprises a faucet body 12 including two mouths 13, 14, and including one or more openings 17, 18 for coupling to the sprayer devices, or the shower heads, or the other nozzles. The faucet assembly 10 further includes a faucet housing 20 having two barrels 21, 25. The barrels 21, 25 each includes an inlet port 34, 35 for coupling to the hot water and the cold water reservoirs respectively and for receiving the hot water and the cold water from the hot water and the cold water reservoirs respectively, and an outlet port 38, 39 coupled to the mouths 13, 14 of the faucet body 12.

The faucet housing 20 further includes a receptacle 22 and two conduits 23, 24 provided and disposed or secured between the barrels 21, 25. A partition 26 is provided in the middle portion of the barrel 21 for separating the interior of the barrel 21 into two spaces 27, 28 which are communicated with the conduits 23, 24 respectively. The barrels 21, 25 each includes a peripheral shoulder 36 formed therein and formed between the space 27 and the inlet port 34 thereof, or close to the inlet ports 34, 35 respectively.

The housing 20 includes a casing 30 formed or provided in the middle portion of the barrel 25 and in the receptacle 22. The casing 30 includes a bore 31 formed therein, and includes an inner thread 40 formed in the outer end portion thereof, and includes two passages 41, 42 formed in the inner portion thereof for communicating the bore 31 of the casing 30 with the hollow chamber 29 of the receptacle 22, and includes two passageways 43, 44 formed in the outer portion thereof for communicating the bore 31 of the casing 30 with the hollow chamber 46 of the barrel 25.

A tube 50 is engaged into the bore 31 of the casing 30, and includes a threaded cap 51 for threading with the inner thread 40 of the casing 30 and for enclosing the bore 31 of the casing 30, and includes a hole 59 formed therein. The tube 50 includes four or more sealing rings 52 engaged on the outer peripheral portion thereof for forming four peripheral channel 53 on the outer peripheral portion thereof, and includes four or more apertures 54 formed therein for communicating the outer peripheral channels 53 with the inner hole 59 of the tube 50.

A valve member 60 is slidably engaged in the hole 59 of the tube 50 for controlling the water and for allowing the hot water and the cold water to be suitably mixed before flowing out of the outlet ports 38, 39 of the barrels 21, 25. The operation of the valve member 60 relative to the tube 50 in order to control the flow and/or mixing of the hot water and the cold water has been disclosed in U.S. Pat. No. 5,839,471 to Yang, and U.S. Pat. No. 6,176,250 to Lin et al., which are taken as references for the present invention.

The faucet assembly further includes one or more check valves 70 engaged in either or both of the barrels 21, 25, particularly disposed in the inlet port 34 of the barrel 21 for preventing the cold water from flowing backward or outward of the barrel 21. The check valve 70 includes a pipe 71 having a peripheral flange 72 extended radially outward therefrom for engaging with the peripheral shoulders 36 of the barrels 21, 25 respectively, and a peripheral recess 73 formed in the outer peripheral portion thereof for receiving a sealing ring 74 which may make a water tight seal between the pipe 71 of the check valve 70 and the barrels 21, 25 respectively.

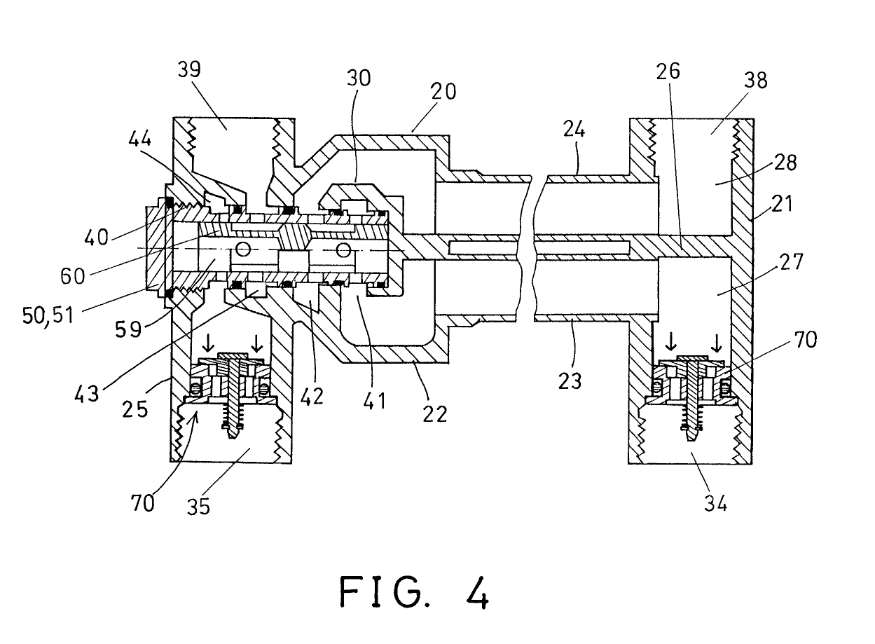

The check valve 70 includes a bore 75 formed in the pipe 71, and one or more orifices 76 formed around the bore 75 of the pipe 71, a valve stem 77 slidably engaged through the bore 75 of the pipe 71, a plug 78 secured to the valve stem 77 for engaging with the pipe 71 and for selectively blocking the orifices 76 of the pipe 71, and a spring 79 is engaged on the valve stem 77 and engaged with the pipe 71 for biasing the plug 78 to engage with the pipe 71 and to block the orifices 76 of the pipe 71 (FIG. 4).

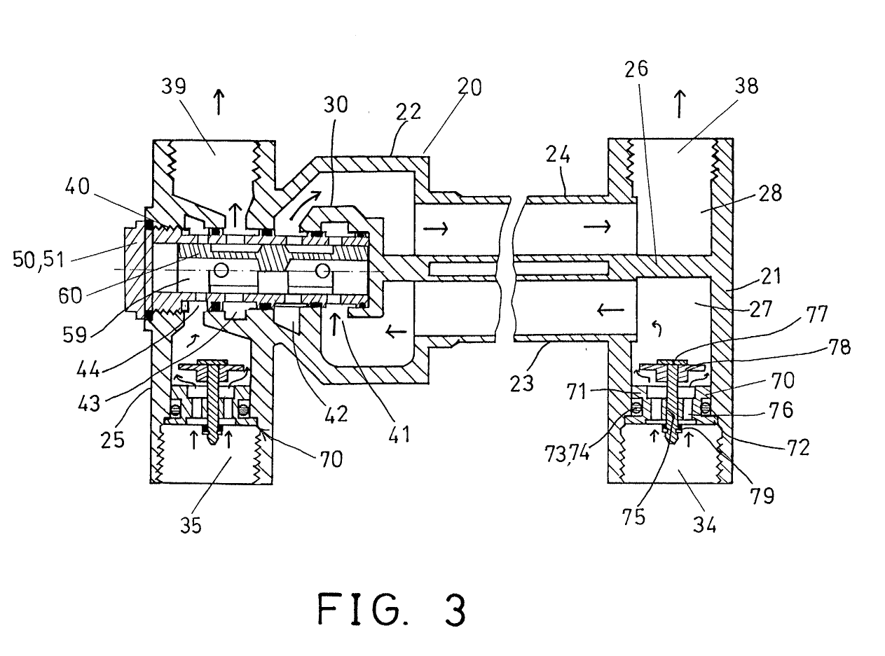

In operation, as shown in FIG. 3, when the hot water and the cold water have been supplied to the inlet ports 34, 35 of the barrels 21, 25 respectively, the plugs 78 and the valve stem 77 may be forced to slide away from the pipe 71 against the spring 79, such that the orifices 76 of the pipe 71 may be opened, and such that the water may flow through the barrels 21, 25 and the conduits 23, 24 and the receptacle 22, and then flow out through the outlet ports 38, 39 of the housing 20 respectively.

As shown in FIG. 4, when no water has been supplied to the inlet ports 34, 35 of the barrels 21, 25, or when the water pressure within the outlet ports 38, 39 of the barrels 21, 25 is less than that of the water pressure within the inlet ports 34, 35, the spring 79 may bias the plug 78 to engage with the pipe 71 and to block the orifices 76 of the pipe 71, such that the water may be prevented from flowing backward and outward through the barrels 21, 25 respectively via the inlet ports 34, 35 of the barrels 21, 25, and such that the water pressure within the housing 20 may be maintained.

Accordingly, the faucet assembly in accordance with the present invention may be provided for suitably mixing the hot water and the cold water, and includes a check valve device for preventing water from flowing backwardly away from the faucet assembly and for maintaining the constant water pressure in the faucet assembly.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A faucet assembly comprising:
a first barrel and a second barrel each including an inlet port for coupling to hot water and cold water reservoirs respectively for receiving hot water and cold water from the reservoirs respectively, and each including a middle portion, said first barrel including a partition provided in said middle portion of said first barrel for separating an interior of said barrel into two spaces,
a receptacle and two conduits coupled between said middle portions of said first and said second barrels, said conduits being communicating with said spaces of said first barrel respectively, said receptacle including a chamber formed and provided therein,
a casing provided in said middle portion of said second barrel and said chamber of said receptacle, and including a bore formed therein, including at least one passage formed therein for communicating said bore of said casing with said chamber of said receptacle, and including at least one passageway formed therein for communicating said bore of said casing with said chamber of said second barrel,
a tube engaged and secured into said bore of said casing, and including a hole formed therein, and including an outer peripheral portion having at least one first and at least one second peripheral channels formed therein, and including two apertures formed therein for communicating said at least one first and said at least one second peripheral channels of said tube with said hole of said tube,
a valve member slidably engaged in said hole of said tube, and
a first check valve including a pipe engaged in said inlet port of said first barrel and having at least one orifice formed through said pipe for allowing the water to flow into said first barrel, a valve stem slidably engaged through said pipe, a plug secured to said valve stem for selectively blocking said at least one orifice of said pipe, and means for biasing said plug to engage with said pipe and to block said at least one orifice of said pipe.

2. The faucet assembly according to claim 1 further comprising a second check valve including a second pipe engaged in said inlet port of said second barrel, said second pipe including at least one orifice formed through said second pipe for allowing the water to flow into said second barrel, a valve stem slidably engaged through said second pipe, a plug secured to said valve stem for engaging with said second pipe and for selectively blocking said at least one orifice of said second pipe, and means for biasing said plug to engage with said second pipe and to block said at least one orifice of said second pipe.
